(19) United States
(12) Patent Application Publication
(10) Pub. No.: US 2026/0065624 A1
(43) Pub. Date: Mar. 5, 2026

(54) IMAGE PROCESSING APPARATUS, IMAGE PROCESSING SYSTEM, OUTPUT APPARATUS, IMAGE PROCESSING METHOD, AND RECORDING MEDIUM IN WHICH IMAGE PROCESSING PROGRAM IS RECORDED

(71) Applicant: Sharp Kabushiki Kaisha, Sakai City (JP)

(72) Inventor: Daisuke IGARASHI, Sakai City (JP)

(21) Appl. No.: 19/299,853

(22) Filed: Aug. 14, 2025

(30) Foreign Application Priority Data
Sep. 4, 2024 (JP) 2024-152097

(51) Int. Cl. G06V 10/26; G06V 10/774; G06V 30/14; G06V 30/148; G06V 30/224; G06V 30/262; G06V 30/412; G06V 30/414

(52) U.S. Cl. CPC G06V 10/273; G06V 10/7747; G06V 30/1448; G06V 30/153; G06V 30/224; G06V 30/262; G06V 30/412; G06V 30/414

(57) ABSTRACT

The display device includes an acquisition processing unit, a rectangle candidate detection processing unit, and a one-character extraction processing unit. The acquisition processing unit acquires image data including characters. The rectangle candidate detection processing unit detects a rectangle candidate of a character from the image data, and calculates a reliability of the detected rectangle candidate. The one-character extraction processing unit corrects, in a case where a first rectangle candidate and a second rectangle candidate detected by the detection processing unit at least partially overlap each other, a reliability of a rectangle candidate to be corrected out of the first rectangle candidate and the second rectangle candidate by using a calculation method for a degree of overlap selected according to a relationship between a type of a first detection target corresponding to the first rectangle candidate and a type of a second detection target corresponding to the second rectangle candidate. The one-character extraction processing unit extracts a one-character rectangle based on the corrected reliability.

### INCORPORATION BY REFERENCE

This application is based upon and claims the benefit of priority from the corresponding Japanese Patent Application No. 2024-152097 filed on Sep. 4, 2024, the entire contents of which are incorporated herein by reference.

### BACKGROUND

The disclosure relates to a technique for executing image processing such as character recognition on an input image.

Techniques for recognizing characters handwritten on documents, forms, and the like (OCR processing) are known in the related art. For example, a technique is known in which a handwritten region including handwritten characters and a printed region including printed characters are extracted from a form, and in which a character sequence in the printed region is recognized in a case where the degree of overlap between the printed region and the handwritten region satisfies a predetermined condition.

However, in the related art, for example, in a case where two characters are close to each other and character region rectangles overlap each other, one of the characters is removed or unnecessary character region rectangles other than the two character region rectangles are extracted. Accordingly, a problem with this technique is a decrease in character recognition accuracy.

### SUMMARY

An object of the present disclosure is to provide an image processing apparatus, an image processing system, an output apparatus, an image processing method, and a recording medium in which an image processing program is recorded that are capable of improving character recognition accuracy for characters that are close to each other.

According to an aspect of the disclosure, an image processing apparatus includes an acquisition processing unit, a detection processing unit, a correction processing unit, and an extraction processing unit. The acquisition processing unit acquires image data including a detection target. The detection processing unit detects a rectangle candidate of the detection target from the image data and calculates a reliability of the detected rectangle candidate. The correction processing unit corrects, in a case where a first rectangle candidate and a second rectangle candidate detected by the detection processing unit at least partially overlap each other, a reliability of a rectangle candidate to be corrected out of the first rectangle candidate and the second rectangle candidate by using a calculation method for a degree of overlap selected according to a relationship between a type of a first detection target corresponding to the first rectangle candidate and a type of a second detection target corresponding to the second rectangle candidate. The extraction processing unit extracts a rectangle of the detection target based on the reliability corrected by the correction processing unit.

According to an aspect of the disclosure, an image processing system includes the image processing apparatus and a training apparatus that generates a trained model by performing machine learning using the training data generated by the image processing apparatus.

According to another aspect of the present disclosure, an output apparatus executes character recognition processing on an input image using the learned model generated by the learning apparatus and outputs a character recognition result.

According to another aspect of the present disclosure, an output apparatus includes a controller that presents a user with a character recognition result obtained by executing character recognition processing in the image processing apparatus.

According to another aspect of the present disclosure, an image processing method is executed by one or more processors and includes acquiring image data including a detection target, detecting a rectangle candidate of the detection target from the image data, calculating a reliability of the detected rectangle candidate, correcting, in a case where the detected first rectangle candidate and the detected second rectangle candidate at least partially overlap each other, a reliability of a rectangle candidate of a correction target between a first rectangle candidate and a second rectangle candidate using a calculation method for a degree of overlap selected according to a relationship between a type of a first detection target corresponding to the first rectangle candidate and a type of a second detection target corresponding to the second rectangle candidate, and extracting a rectangle of the detection target based on the corrected reliability.

According to another aspect of the present disclosure, a recording medium is provided in which a program is recorded, the program causing one or more processors to execute acquiring image data including a detection target, detecting a rectangle candidate of the detection target from the image data and calculating a reliability of the detected rectangle candidate, correcting, in a case where the detected first rectangle candidate and the second rectangle candidate at least partially overlap each other, a reliability of a rectangle candidate of a correction target between a first rectangle candidate and a second rectangle candidate using a calculation method for a degree of overlap selected according to a relationship between a type of a first detection target corresponding to the first rectangle candidate and a type of a second detection target corresponding to the second rectangle candidate, and extracting a rectangle of the detection target based on the corrected reliability.

According to the present disclosure, an image processing apparatus, an image processing system, an output apparatus, an image processing method, and a recording medium in which an image processing program is recorded can be provided that are capable of improving character recognition accuracy for characters that are close to each other.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a function block diagram illustrating a configuration of an image processing system according to an embodiment of the disclosure.

FIG. 2 is a diagram illustrating an example (receipt) of an input image according to an embodiment of the disclosure.

FIG. 3 is a view illustrating an example of one-character rectangles detected in an input image according to an embodiment of the present disclosure.

FIG. 4 is a diagram illustrating an example of one-character rectangles extracted in related character recognition processing.

FIG. 5 is a diagram illustrating an example of one-character rectangles extracted in the related character recognition process.

FIG. 6 is a diagram illustrating an example of rectangle candidates detected in character recognition processing according to an embodiment of the disclosure.

FIG. 7 is a diagram illustrating an example of rectangle candidates detected in the character recognition processing according to an embodiment of the disclosure.

FIG. 8 is a graph illustrating a relationship between the degree of overlap (index) and a correction coefficient used in the character recognition processing according to an embodiment of the present disclosure.

FIG. 9 is a diagram illustrating an example of a calculation method for a first index and a second index according to an embodiment of the disclosure.

FIG. 10 is a diagram illustrating a specific example of correction processing using the first index (IoU) according to an embodiment of the disclosure.

FIG. 11 is a diagram illustrating a specific example of correction processing using the first index (IoU) according to an embodiment of the disclosure.

FIG. 12 is a diagram illustrating a specific example of correction processing using the second index (IoS) according to an embodiment of the disclosure.

FIG. 13 is a diagram illustrating a specific example of correction processing using the second index (IoS) according to an embodiment of the disclosure.

FIG. 14 is a flowchart illustrating an example of a procedure of character recognition processing executed in an image processing apparatus according to an embodiment of the disclosure.

### DETAILED DESCRIPTION

Embodiments of the disclosure will be described below with reference to the drawings. Note that the following embodiments are specific examples of the disclosure, and do not limit the technical scope of the disclosure.

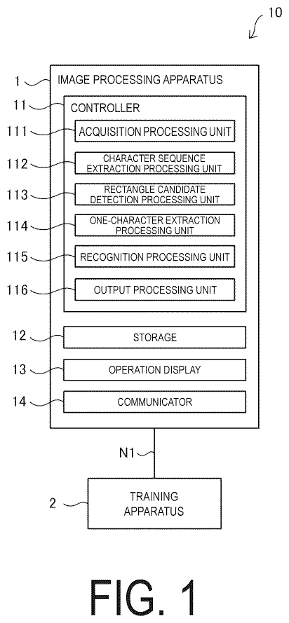

FIG. 1 is a block diagram illustrating a configuration of an image processing system 10 according to an embodiment of the disclosure. The image processing system 10 includes an image processing apparatus 1 and a training apparatus 2. The image processing apparatus 1 is an information processing apparatus that recognizes character sequences included in an input image (image data), executes character recognition processing (OCR processing) on the recognized character sequence, and outputs character recognition results. The training apparatus 2 is an information processing apparatus that performs machine learning using input data (training data) input from the image processing apparatus 1 to generate a trained model for performing character recognition on input images.

As illustrated in FIG. 1, the image processing apparatus 1 includes a controller 11, a storage 12, an operation display 13, a communicator 14, and the like. The image processing apparatus 1 may be one or more cloud servers or one or more physical servers.

The communicator 14 is a communication interface for connecting the image processing apparatus 1 to a network N1 in a wired or wireless manner and executing data communication with external equipment (for example, the training apparatus 2) via the network N1 according to a predetermined communication protocol. The network N1 includes, for example, the Internet, a LAN, or the like.

The operation display 13 is a user interface including a display such as a liquid crystal display or an organic EL display that displays various types of information, and an operation inputter such as a mouse, a keyboard, or a touch panel that receives an operation.

The storage 12 is a non-volatile storage such as a Hard Disk Drive (HDD), a Solid State Drive (SSD), or a flash memory that stores various types of information. The storage 12 stores a control program such as a character recognition program (an example of an image processing program of the disclosure) for enabling the controller 11 to execute character recognition processing to be described below. For example, the character recognition program is non-transiently recorded in a computer-readable recording medium such as a CD or a DVD, read by a reading apparatus (not illustrated) such as a CD drive or a DVD drive included in the image processing apparatus 1, and stored in the storage 12. Note that the character recognition program may be distributed from a cloud server and stored in the storage 12.

The storage 12 also stores image data (scanned data or the like) of documents or the like acquired from external equipment.

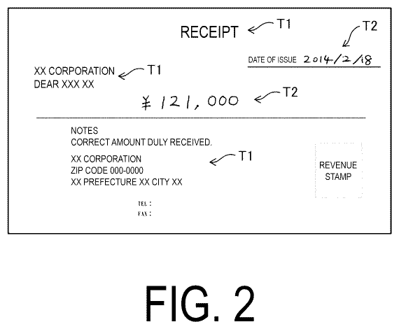

FIG. 2 illustrates a receipt as an example of a document (form). As illustrated in FIG. 2, the receipt includes multiple items such as date of issue, recipient, contact information of an issuer, and the amount of money. The receipt in FIG. 2 includes a printed character T1 and a handwritten character T2. For example, a user scans the receipt using a scanner, a multi-function printer, or the like and uploads the image data (input image) to the image processing apparatus 1. The user also photographs the receipt by using an operation terminal (for example, a smartphone) and uploads the image data to the image processing apparatus 1. Upon acquiring the image data of the receipt, the controller 11 stores the image data in the storage 12. As another embodiment, the controller 11 may acquire a document file of the receipt created in the external equipment and store the document file in the storage 12.

The controller 11 includes a control element such as a Central Processing Unit (CPU), a Read Only Memory (ROM), and a Random Access Memory (RAM). The CPU is a processor that performs various types of arithmetic processing. The ROM stores in advance control programs such as a BIOS and an OS for causing the CPU to execute various types of processing. The RAM stores various types of information and is used as a temporary storage memory (work area) for the various types of processing executed by the CPU. The controller 11 controls the image processing apparatus 1 by causing the CPU to execute various types of the control programs stored in advance in the ROM or the storage 12.

In the related art, for example, in a case where two characters are close to each other and character region rectangles overlap each other, one of the characters is removed or unnecessary character region rectangles other than the two character region rectangles are extracted. Accordingly, a problem with this technique is a decrease in character recognition accuracy.

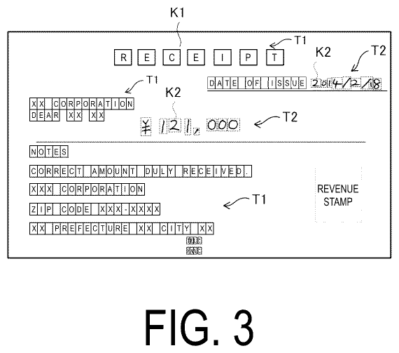

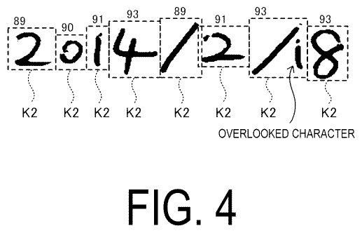

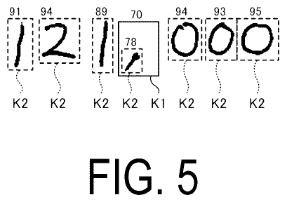

For example, in FIG. 3, an image of a receipt illustrates a one-character rectangle T1 of printed characters K1 and a one-character rectangle T2 of handwritten characters K2. In the handwritten characters T2 “2014/2/18” of the issue date illustrated in FIG. 4, when the characters “/” and “1” are close to each other, “1” may fail to be extracted as a one-character rectangle and may be removed. For example, when Non-Maximum Suppression (NMS), which is a known object detection technique, is used to perform processing of leaving a rectangle candidate having the highest score (reliability) among the detected rectangle candidates, the rectangle candidate of “/”, having the higher score among the detected characters “/” and “1” is extracted as a one-character rectangle, and the rectangle candidate of “1” having the lower score is removed. Soft-NMS may be used as a method of extracting, as a one-character rectangle, a rectangle candidate having a low score. However, although Soft-NMS can be used to extract “1”, having a low score, as a one-character rectangle, a problem with this method is that the character “,” is extracted as a printed one-character rectangle in addition to a handwritten one-character rectangle, as illustrated in FIG. 5, for example.

As described above, in the related art, it is difficult to prevent, at the same time, both removal of adjacent (or overlapping) one-character rectangles and extraction of unnecessary one-character rectangles, leading to reduced character recognition accuracy. On the other hand, the image processing apparatus 1 according to the present disclosure is configured to enable improvement of character recognition accuracy for characters close to each other as described below.

Specifically, the controller 11 includes various processing units such as an acquisition processing unit 111, a character sequence extraction processing unit 112, a rectangle candidate detection processing unit 113, a one-character extraction processing unit 114, a recognition processing unit 115, and an output processing unit 116 as illustrated in FIG. 1. Note that the controller 11 functions as the various processing units by executing various types of processing in accordance with the character recognition program. Further, some or all of the processing units included in the controller 11 may be constituted by an electronic circuit. Note that the character recognition program may be a program for causing a plurality of processors to function as the various types of processing units.

The acquisition processing unit 111 acquires an input image including characters to be detected. Specifically, the acquisition processing unit 111 acquires an image for character recognition (character image data). For example, the acquisition processing unit 111 acquires character image data of a form image containing handwritten characters, printed characters, and the like, such as a receipt illustrated in FIG. 2.

The character sequence extraction processing unit 112 extracts a character-sequence rectangle corresponding to a character sequence constituted by a plurality of characters from the input image. Specifically, the character sequence extraction processing unit 112 executes recognition processing of a document part in the input image acquired by the acquisition processing unit 111 to execute character sequence recognition processing for recognizing a character sequence constituted by a plurality of characters. In addition, the character sequence extraction processing unit 112 sets a character-sequence rectangle corresponding to the recognized character sequence. That is, the character sequence extraction processing unit 112 recognizes a cluster of a plurality of characters as a character-sequence rectangle. For example, from the input image illustrated in FIG. 2, the character sequence extraction processing unit 112 extracts character-sequence rectangles corresponding to a handwritten character sequence (“2014/2/18”, “\121,000”).

The one-character extraction processing unit 113 detects, from the input image, a plurality of one-character rectangle candidates corresponding to the respective plurality of characters. In the present embodiment, the rectangle candidate represents a rectangle that is a candidate for a one-character rectangle. The rectangle candidate detection processing unit 113 calculates a score (reliability, probability) of the detected rectangle candidate. Specifically, the rectangle candidate detection processing unit 113 performs one-character recognition processing of recognizing characters in single character units in the input image acquired by the acquisition processing unit 111. In addition, the rectangle candidate detection processing unit 113 extracts rectangle candidates corresponding to the recognized characters. That is, the rectangle candidate detection processing unit 113 recognizes smallest units of characters as character-sequence rectangles.

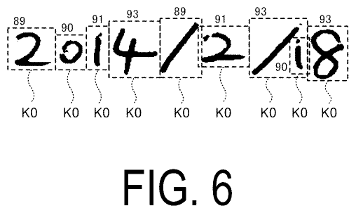

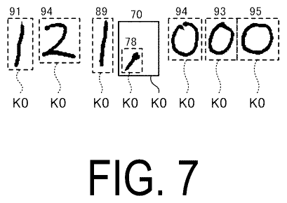

For example, the rectangle candidate detection processing unit 113 detects a plurality of rectangle candidates corresponding to the characters of the printed character T1 and a plurality of rectangle candidates corresponding to the characters of the handwritten character T2. FIG. 6 illustrates an example in which nine rectangle candidates K0 are detected in the character-sequence rectangle of the issue date “2014/2/18 ” of the handwritten character T2. FIG. 7 shows an example in which eight rectangle candidates T2 are detected in the character-sequence rectangle of the amount of money “121000” of the handwritten character K0. Note that, in the case of “,” illustrated in FIG. 7, a rectangle candidate of a handwritten character and a rectangle candidate of a printed character are detected in an overlapping manner. As illustrated in FIGS. 6 and 7, the rectangle candidate detection processing unit 113 calculates a score of each detected rectangle candidate.

The one-character extraction processing unit 114 extracts a plurality of one-character rectangles corresponding to each character from the rectangle candidates detected by the rectangle candidate detection processing unit 113. Specifically, in a case where a plurality of rectangle candidates are away from each other and do not overlap each other, the one-character extraction processing unit 114 extracts each rectangle candidate as a one-character rectangle. For example, in the example illustrated in FIG. 6, the one-character extraction processing unit 114 extracts each of “2”, “0”, “1”, “4”, “/”, “2”, and “8” as a one-character rectangle. In the example illustrated in FIG. 7, the one-character extraction processing unit 114 extracts each of “1”, “2”, “1”, “0”, “0”, and “0” as a one-character rectangle.

In contrast, when a plurality of rectangle candidates are close to each other and overlap each other, the one-character extraction processing unit 114 executes correction processing of correcting the score (reliability) of each rectangle candidate. For example, in the example illustrated in FIG. 6, the one-character extraction processing unit 114 executes the correction processing because the rectangle candidate of the character “/” overlaps the rectangle candidate of the character “1”. In the example illustrated in FIG. 7, the one-character extraction processing unit 114 executes the correction processing because the rectangle candidate of the handwritten character detected for the character “,” overlaps the rectangle candidate of the printed character detected for the character “,”. The one-character extraction processing unit 114 is an example of the correction processing unit and the extraction processing unit of the disclosure.

A specific example of the correction processing will be described below. In a case where the first and second rectangle candidates detected by the rectangle candidate detection processing unit 113 at least partially overlap each other, the one-character extraction processing unit 114 executes correction processing of correcting the score (reliability) of the rectangle candidate to be corrected out of the first rectangle candidate and the second rectangle candidate by using a method of calculating the degree of overlap between the first and second characters, which is selected according to the relationship between the type of the first character corresponding to the first rectangle candidate and the type of the second character corresponding to the second rectangle candidate. In addition, the one-character extraction processing unit 114 extracts one-character rectangles corresponding to the corrected characters. Note that one of the first and second rectangle candidates having a lower score (reliability) is to be corrected.

That is, the one-character extraction processing unit 114 corrects the score of the rectangle candidate having a lower score out of the first rectangle candidate and the second rectangle candidate.

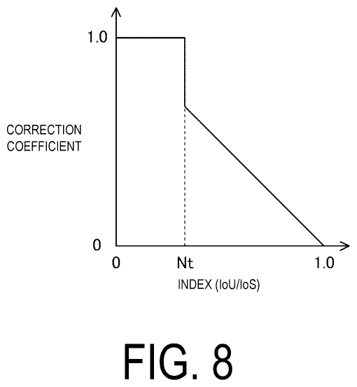

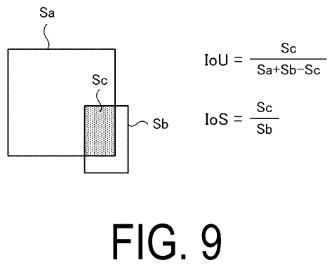

For example, the one-character extraction processing unit 114 corrects the score of the rectangle candidate to be corrected by using Soft-NMS and a correction coefficient based on an index (degree of overlap) that varies depending on the type (attribute) of the rectangle candidate. FIG. 8 is a graph illustrating a relationship between the correction coefficient and the index (first index: IoU, second index: IoS) indicating the degree of overlap between the plurality of rectangle candidates. FIG. 9 illustrates a specific example of a method of calculating the first index and the second index. As illustrated in FIG. 8, a graph having a characteristic that the correction coefficient decreases with increasing degree of overlap (ratio) is an example of the correction data of the present disclosure. The method of calculating the first index is an example of a first calculation method of the present disclosure, and the method of calculating the second index is an example of a second calculation method of the present disclosure. In the graph illustrated in FIG. 8, the correction coefficient is set to 1.0 for a section from index 0 to index Nt (threshold value)in which the degree of overlap is low, and the correction processing is omitted in a section in which the degree of overlap is less than the threshold value.

In FIG. 9, for example, in a case where the area of the first rectangle candidate is denoted by Sa, the area of the second rectangle candidate is denoted by Sb, and the area of the portion where the first rectangle candidate and the second rectangle candidate overlap is denoted by Sc, the first index (Intersection over Union; IoU) is expressed by Sc/(Sa+Sb−Sc), and the second index (Intersection over smaller; IoS) is expressed by Sc/Sb. Here, the rectangle candidate to be corrected is assumed to be the second rectangle candidate.

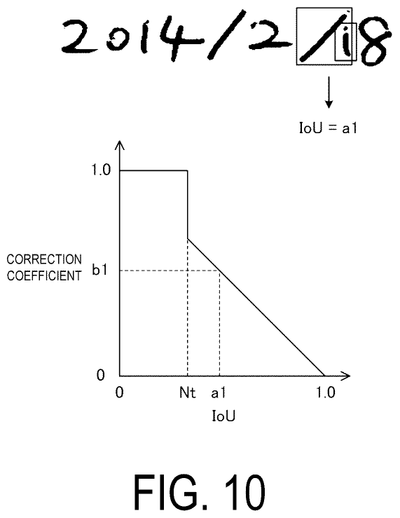

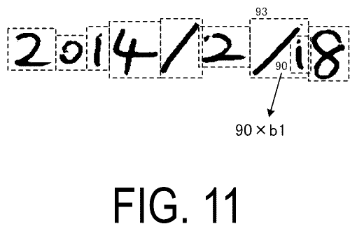

Taking the issue date “2014/2/18” of the handwritten character T2 as an example, since both the first rectangle candidate “/” and the second rectangle candidate “1” are handwritten characters (the same type), the one-character extraction processing unit 114 calculates the correction coefficient using the first index (IoU) as illustrated in FIG. 10. Specifically, the one-character extraction processing unit 114 calculates the first index (IoU =Sc/(Sa+Sb−Sc)) based on the area Sa of the first rectangle candidate “/”, the area Sb of the second rectangle candidate “1”, and the overlapping area Sc between both rectangle candidates (see FIG. 9). Here, “a1” is assumed to be calculated as the first index (IoU). Then, the one-character extraction processing unit 114 calculates a correction coefficient corresponding to IoU =a1 using the graph. Here, “b1” is assumed to be calculated as the correction coefficient. Here, when the second rectangle candidate “1” to be corrected has a score of “90”, the one-character extraction processing unit 114 corrects the score by multiplying the score by the correction coefficient as illustrated in FIG. 11. As a result, the corrected score of the second rectangle candidate “1” is “90×b1”. In a case where the corrected score is equal to or greater than the threshold value, the one-character extraction processing unit 114 extracts “1” of the second rectangle candidate to be corrected as a one-character rectangle. This enables the character “1”, which is otherwise removed in the related art (see FIG. 4), to be extracted as a one-character rectangle.

As described above, when the character of the first rectangle candidate and the character of the second rectangle candidate are of the same type, the one-character extraction processing unit 114 sets the correction coefficient to a large value by using the first index (IoU) that is less affected by the degree of overlap. This enables the corrected score to be less easily reduced, allowing the rectangle candidate to be corrected to be less easily erased. As a result, the rectangle candidate can be appropriately extracted as a one-character rectangle. Note that the “same type” includes a case where the characters of the plurality of rectangle candidates are handwritten characters and a case where the characters of the plurality of rectangle candidates are printed characters.

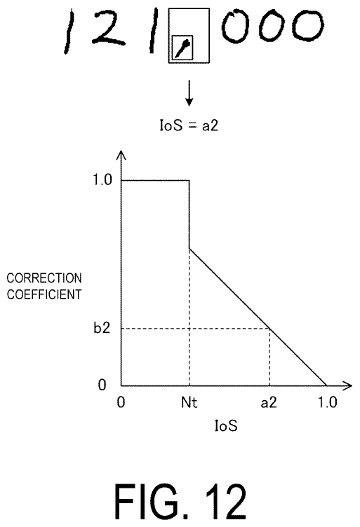

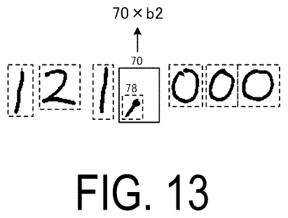

In contrast, for the amount of money “121,000” of the handwritten character T2, the handwritten character of the first rectangle candidate and the printed character of the second rectangle candidate corresponding to the character “,” are different in type from each other, and thus, as illustrated in FIG. 12, the one-character extraction processing unit 114 calculates the correction coefficient using the second index (IoS). Specifically, the one-character extraction processing unit 114 calculates the second index (IoS =Sc/Sb) based on the area Sb of the second rectangular candidate of the printed character and the overlapping area Sc (see FIG. 9). Here, “a2” is assumed to be calculated as the second index (IoS). Then, the one-character extraction processing unit 114 calculates a correction coefficient corresponding to IoS=a2 using the graph. Here, “b2” is assumed to be calculated as the correction coefficient. Here, in a case where the character “,” of the second rectangle candidate to be corrected has a score of “70”, the one-character extraction processing unit 114 corrects the score by multiplying the score by the correction coefficient as illustrated in FIG. 13. As a result, the corrected score of the second rectangle candidate “,” is “70×b2”. In a case where the corrected score is less than the threshold value, the one-character extraction processing unit 114 erases the second rectangle candidate to be corrected. This enables erasure of the rectangular candidate of the printed type, which is otherwise unnecessarily extracted in the related art (see FIG. 5).

As described above, in a case where the character of the first rectangle candidate and the character of the second rectangle candidate are of different types, the correction coefficient is set to a small value by using the second index (IoS), which is greatly affected by the degree of overlap. This enables the corrected score to be more easily reduced, allowing the rectangle candidate to be corrected to be more easily erased. This enables an unnecessary one-character rectangle to be prevented from being extracted.

The “different types” include a combination of handwriting and printed characters of a plurality of rectangle candidates.

As described above, the one-character extraction processing unit 114 selects a calculation method depending on whether the first character and the second character are of the same type. Specifically, the one-character extraction processing unit 114 selects the first calculation method using the first index (IoU) in a case where both the first character and the second character are handwritten characters or printed characters (see FIGS. 10 and 11), and selects the second calculation method using the second index (IoS) in a case where one of the first character and the second character is a handwritten character and the other is a printed character (see FIGS. 12 and 13). The first calculation method is a method of calculating a ratio of the area of the overlapping portion to the total area of the first rectangle candidate and the second rectangle candidate (degree of overlapping), and the second calculation method is a method of calculating the ratio of the area of the overlapping portion to the area of the rectangle candidate to be corrected.

That is, in a case where both the first character and the second character are handwritten characters or printed characters, the one-character extraction processing unit 114 calculates a correction coefficient corresponding to the ratio calculated by the first calculation method, and multiplies the score of the rectangular candidate to be corrected by the correction coefficient to correct the score, and in a case where one of the first character and the second character is a handwritten character and the other is a printed character, the one-character extraction processing unit 114 calculates a correction coefficient corresponding to the ratio calculated by the second calculation method, and multiplies the score of the rectangular candidate to be corrected by the correction coefficient to correct the score. The one-character extraction processing unit 114 calculates the correction coefficient with reference to correction data (graph shown in FIG. 8) having a characteristic that the correction coefficient decreases with increasing ratio.

The one-character extraction processing unit 114 extracts the rectangle candidate to be corrected as a one-character rectangle when the corrected score is equal to or greater than the threshold value, and does not extract the rectangle candidate to be corrected as a one-character rectangle when the corrected score is less than the threshold value.

Accordingly, as illustrated in FIG. 9, the second index (IoS) of the second calculation method is less affected by the area of the first rectangle candidate and more affected by the overlapping area in the rectangle candidate to be corrected, and thus the score decreases with increasing degree of overlap, allowing the rectangle candidate to be more easily excluded. In contrast, the first index (IoU) of the first calculation method is more affected by the area of the first rectangle candidate, and thus is less affected by the degree of overlap, allowing the score to be easily increased. As a result, the rectangle candidate is less easily excluded.

The recognition processing unit 115 executes character recognition processing (OCR processing) on the character sequence. For example, the recognition processing unit 115 executes the OCR processing based on a character-sequence rectangle extracted by the character sequence extraction processing unit 112, and a plurality of one-character rectangles extracted by the one-character extraction processing unit 114.

For example, the recognition processing unit 115 executes pre-processing (processing such as background removal, inversion, ruled line removal, seal removal, and italic correction) for improving the accuracy of OCR, and then executes the existing OCR processing.

The output processing unit 116 outputs the OCR result (character recognition result).

For example, the output processing unit 116 outputs the OCR result to the request source that has output the character recognition request for the input image.

In addition, the output processing unit 116 outputs training data to the training apparatus 2 (see FIG. 1). The controller 11 generates a one-character rectangle including a score corrected by the one-character extraction processing unit 114, as training data used for machine learning. The output processing unit 116 outputs, to the training apparatus 2, training data (teacher data) including a one-character rectangle subjected to the correction processing executed by the one-character extension processing unit 114.

The training apparatus 2 performs machine learning using the training data generated by the image processing apparatus 1 to generate a trained model.

Note that the machine learning involves algorithms such as supervised learning using supervised data, unsupervised learning using unsupervised data, and reinforcement learning. Further, in order to realize these techniques, a method called “deep learning” is used in which extraction of a feature amount itself is learned. In the present embodiment, the training apparatus 2 includes a trained model based on the various algorithms described above. By performing machine learning using supervised data and unsupervised data as input data, the training apparatus 2 can generate a trained model for executing character recognition processing.

The trained model can be applied to the image processing apparatus 1. For example, as illustrated in FIG. 1, when an input image for character recognition is input to the image processing apparatus 1, the image processing apparatus 1 performs OCR processing on the input image using the trained model to output an OCR result. The image processing apparatus 1 is an example of the output apparatus of the disclosure.

In addition, the trained model may be downloaded to the image processing apparatus 1 for use, or may be stored in a server (cloud server) and used by accessing the server from a user terminal via the Internet or the like. For example, when an arbitrary input image is input to a user terminal, the trained model outputs an optimal character recognition result. That is, the user terminal may execute the OCR processing on the input image using the trained model generated by the training apparatus 2 and output the OCR result. In addition, the user terminal may include a controller that presents the user with an OCR result obtained by executing the OCR processing on the character sequence using the corrected one-character rectangle corrected in the image processing apparatus 1. The user terminal is an example of the output apparatus of the disclosure.

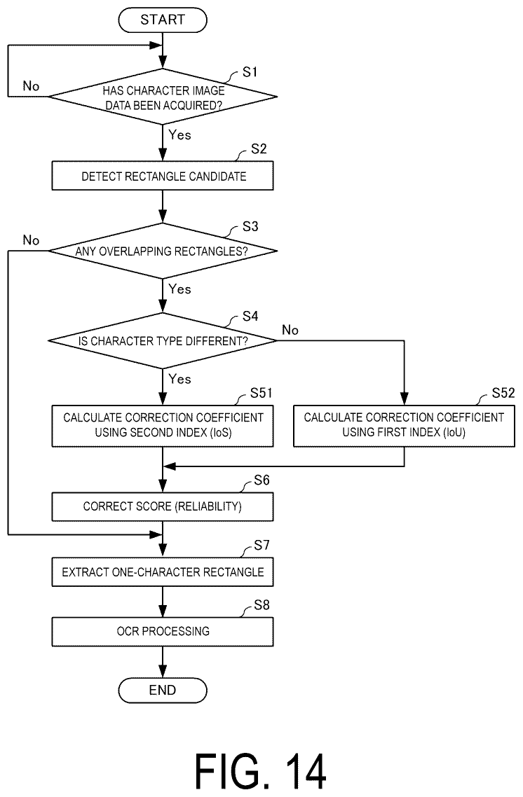

Character Recognition Processing FIG. 14 is a flowchart illustrating an example of the procedure of the character recognition processing executed in the image processing apparatus 1.

Note that the disclosure can be understood as a character recognition method (image processing method of the disclosure) in which one or more steps included in the character recognition processing are executed. In addition, one or more steps included in the character recognition processing described herein may be omitted as appropriate. In addition, each of the steps of the character recognition processing may be executed in a different order to the extent that similar effects are obtained. Furthermore, although the example in which the controller 11 of the image processing apparatus 1 executes each of the steps of the character recognition processing has been exemplified in the embodiment, in another embodiment, one or more processors may execute each of the steps of the character recognition processing in a distributed manner. In addition, when acquiring character image data from external equipment, the controller 11 can execute the character recognition processing in parallel for each piece of character image data.

### Step S1

In step S1, the controller 11 determines whether character image data has been acquired. Specifically, the controller 11 acquires character image data of a form (for example, the receipt in FIG. 2) from external equipment or the like. Upon acquiring character image data (S1: Yes), the controller 11 transitions the processing to step S2. The controller 11 awaits until character image data is acquired (S1: No).

Step S2 In step S2, the controller 11 detects, from the character image data, a plurality of one-character rectangles corresponding to a respective plurality of characters. To be specific, the controller 11 detects, in the input image, characters in single character units and defines the rectangle of each detected character as a rectangle candidate. For example, as illustrated in FIG. 6, the controller 11 detects nine rectangle candidates K0 in the character-sequence rectangle of the issue date “2014/2/18” of the handwritten character T2. For example, as illustrated in FIG. 7, the controller 11 detects eight rectangle candidates K0 in the character-sequence rectangle of the amount of money “121,000” of the handwritten character T2.

Step S3 In step S3, the controller 11 determines whether the plurality of one-character rectangles extracted in step S2 include overlapping rectangle candidates. In another embodiment, the controller 11 may determine whether any two of the plurality of rectangle candidates has less than a predetermined distance between the rectangle candidates.

Upon determining that the plurality of rectangle candidates include overlapping rectangle candidates (S3: Yes), the controller 11 proceeds to the processing of step S4. On the other hand, upon determining that the plurality of rectangle candidates include no overlapping rectangle candidates (S3: No), the controller 11 proceeds to the processing of step S7.

Step S4 In step S4, the controller 11 determines whether the overlapping rectangle candidates are of different types. Specifically, the controller 11 determines whether the character types of the overlapping rectangle candidates correspond to a combination of a handwritten character and a printed character. In a case where the character types of the overlapping rectangle candidates correspond to a combination of a handwritten character and a printed character (S4: Yes), the controller 11 proceeds to the processing of step S51. On the other hand, in a case where the character types of the overlapping rectangle candidates correspond to a combination of handwritten characters or a combination of printed characters (S4: No), the controller 11 proceeds to the processing of step S52.

Step S51 In step S51, the controller 11 calculates a correction coefficient for correcting the score of the rectangle candidate to be corrected using the second index (IoS) (see FIG. 9).

Specifically, the controller 11 calculates the correction coefficient corresponding to the second index (IoS) using the graph illustrated in FIG. 8. For example, in the example illustrated in FIG. 7, since the character “,” of the second rectangle candidate is a combination of the rectangle candidate of the handwritten character and the rectangle candidate of the printed character, the controller 11 calculates the second index (IoS) (IoS =a2) and calculates the correction coefficient “b2” corresponding to the second index “a2” as illustrated in FIG. 12. After step S51, the controller 11 proceeds to the processing of step S6.

Step S52 In step S52, the controller 11 uses the first index (IoU) to calculate a correction coefficient for correcting the score of the rectangle candidate to be corrected (see FIG. 9). Specifically, the controller 11 uses the graph illustrated in FIG. 8 to calculate the correction coefficient corresponding to the first index (IoU). For example, in the example illustrated in FIG. 6, the characters “/” and “1” of the second rectangle candidate correspond to a combination of rectangle candidates of handwritten characters, and thus the controller 11 calculates the first index (IoU) (IoU =a1) and calculates the correction coefficient “b1” corresponding to the first index “a1” as illustrated in FIG. 10. After step S52, the controller 11 proceeds to the processing of step S6.

Step S6 In step S6, the controller 11 corrects the score of the rectangle candidate to be corrected. To be specific, in a case where the overlapping rectangle candidates are of different types (S4: Yes), the controller 11 corrects the score of the second rectangle candidate to be corrected by using the correction coefficient calculated by the second index (IoS) (step S51). For example, as illustrated in FIGS. 12 and 13, in a case where the character “,” of the second rectangle candidate to be corrected has a score of “70”, the controller 11 multiplies the score by the correction coefficient to correct the score to “70×b2”.

In a case where the overlapping rectangle candidates are of the same type (S4: No), the controller 11 uses the correction coefficient calculated by the first index (IoU) (step S52) to correct the score of the second rectangle candidate to be corrected. For example, as illustrated in FIGS. 10 and 11, in a case where the character “1” of the second rectangle candidate to be corrected has a score of “90”, the controller 11 multiplies the score by the correction coefficient to correct the score to “90×b1”.

Step S7 In step S7, the controller 11 extracts a one-character rectangle. Specifically, in a case where each rectangle candidate has a score equal to or greater than a threshold value, the controller 11 extracts the rectangle candidate as a one-character rectangle. In a case where a plurality of rectangle candidates overlap (S3: Yes), the controller 11 extracts the rectangle candidates as one-character rectangles in a case where the scores corrected by the correction coefficients (steps S51 and S52) are equal to or greater than the threshold values. Although not illustrated in FIG. 14, the controller 11 extracts a character-sequence rectangle based on the input image.

### Step S8

In step S8, the controller 11 executes the OCR processing. Specifically, the controller 11 executes existing pre-processing such as background removal, inversion, ruled line removal, seal removal, and italic correction. The controller 11 also executes the existing OCR processing on the character-sequence rectangle and the one-character rectangle that have undergone the pre-processing of the OCR processing. When the OCR processing is executed, the controller 11 outputs the OCR result.

As described above, the controller 11 executes the character recognition processing. In addition, the controller 11 repeatedly executes the character recognition processing each time character image data (input image) for character recognition is acquired.

As described above, the image processing apparatus 1 according to the present embodiment executes acquiring image data including a character to be detected, detecting a rectangle candidate of the character from the image data, calculating a reliability of the detected rectangle candidate, correcting the reliability of a rectangle candidate to be corrected between a first rectangle candidate and a second rectangle candidate by using a calculation method for a degree of overlap selected according to a relationship between a type of a first character corresponding to the first rectangle candidate and a type of a second character corresponding to the second rectangle candidate in a case where the detected first rectangle candidate and the detected second rectangle candidate at least partially overlap each other, and extracting a rectangle of the character based on the corrected reliability.

According to the above configuration, for example, in a case where the first character and the second character are of the same type (for example, handwritten characters or printed characters), the corrected reliability (score) can be less easily reduced by using the first calculation method using the first index (IoU) that is less affected by the degree of overlap. This allows the rectangle candidate to be corrected to be less easily erased. This enables appropriate extraction as a one-character rectangle. In contrast, in a case where the first character and the second character are of different types (for example, a combination of a handwritten character and a printed character), the corrected reliability (score) can be easily reduced by using the second calculation method using the second index (IoS) that is more affected by the degree of overlap. This allows the rectangle candidate to be corrected to be easily erased. This prevents an unnecessary one-character rectangle from being extracted.

The above-described embodiment enables simultaneous achievement of both prevention of removal of adjacent character rectangles and prevention of extraction of unnecessary character rectangles, thus allowing improvement of the character recognition accuracy for characters close to each other.

Note that the control portion 11 of the image processing apparatus 1 may cause the operation display 13 to display, in an identifiable manner, the calculation method to be used for the correction processing, out of the first calculation method and the second calculation method. In addition, the controller 11 may cause the operation display 13 to display the rectangle candidates of the respective characters and to display, in an identifiable manner, the types of the first character and the second character whose rectangle candidates overlap each other. For example, the controller 11 may cause the frame images of the first and second rectangle candidates to be displayed in different colors.

In the above-described embodiment, a character is illustrated as a detection target, but the detection target of the present disclosure is not limited to a character. The detection target may be an object, a person, or the like. In addition, the detection target of the present disclosure may be a combination of a character and a non-character.

In addition, in the image processing system 10, the image processing apparatus 1 and the training apparatus 2 may be configured as integrated equipment. In addition, the processing units (the acquisition processing unit 111, the character sequence extraction processing unit 112, the rectangle candidate detection processing unit 113, the one-character extraction processing unit 114, the recognition processing unit 115, and the output processing unit 116) of the image processing apparatus 1 may be arranged in multiple pieces of equipment in a distributed manner.

In the image processing system 10 according to the present disclosure, the controller 11 of the image processing apparatus 1 controls the entire image processing apparatus 1. The controller 11 enables various functions by loading and executing various programs stored in the storage 12 (for example, a storage component or ROM). The controller 11 may be implemented by one or multiple control devices/arithmetic devices (such as a Central Processing Unit (CPU), a System on a Chip (SoC)). In addition, the controller 11 may include one or multiple control circuits (electronic circuits).

Supplementary Notes of Disclosure Hereinafter, an outline of the disclosure extracted from the above-described embodiments will be described as supplementary notes. Note that configurations and processing functions described in the following supplementary notes can be selected and combined as desired.

### Supplementary Note 1

An image processing apparatus comprising:

an acquisition processing circuit that acquires image data including a plurality of detection targets;

a detection processing circuit that detects a plurality of rectangle candidates corresponding to the plurality of detection targets from the image data and calculates a reliability for each of the detected rectangle candidates;

a correction processing circuit that corrects, in a case where a first rectangle candidate and a second rectangle candidate detected by the detection processing circuit at least partially overlap each other, a reliability of a rectangle candidate to be corrected out of the first rectangle candidate and the second rectangle candidate by using a calculation method for a degree of overlap selected according to a relationship between a type of a first detection target corresponding to the first rectangle candidate and a type of a second detection target corresponding to the second rectangle candidate; and an extraction processing circuit that extracts rectangles corresponding to the plurality of detection targets based on the reliability corrected by the correction processing circuit.

### Supplementary Note 2

The image processing apparatus according to Supplementary Note 1, wherein the detection target is a character, the correction processing circuit selects the calculation method depending on whether the type of the first character and the type of the second character are the same.

Supplementary Note 3 The image processing apparatus according to Supplementary Note 2, wherein the type includes a handwritten character and a printed character, the correction processing circuit selects a first calculation method in a case where both the first character and the second character are the handwritten characters or the typed characters, and selects a second calculation method when one of the first character and the second character is the handwritten character and the other is the typed character.

Supplementary Note 4 The image processing apparatus according to Supplementary Note 3, wherein the first calculation method is a method of calculating a ratio of an area of an overlapping portion to a total area of the first rectangle candidate and the second rectangle candidate, and the second calculation method is a method of calculating a ratio of the area of the overlapping portion to an area of the candidate rectangle to be corrected.

Supplementary Note 5 The image processing apparatus according to Supplementary Note 4, wherein

### The Correction Processing Circuit:

in a case where both the first character and the second character are the handwritten characters or the printed characters, calculates a correction coefficient corresponding to the ratio calculated by the first calculation method, and corrects a reliability of the rectangle candidate to be corrected by multiplying the reliability by the correction coefficient; and in a case where one of the first character and the second character is the handwritten character and the other is the printed character, calculates a correction coefficient corresponding to the ratio calculated by the second calculation method, and corrects the reliability of the rectangle candidate to be corrected by multiplying the reliability by the correction coefficient.

Supplementary Note 6 The image processing apparatus according to Supplementary Note 5, wherein the correction processing circuit calculates the correction coefficient by referring to correction data having a characteristic that the correction coefficient decreases with an increase in the ratio.

### Supplementary Note 7

The image processing device according to any one of Supplementary Notes 1 to 6, wherein the extraction processing circuit extracts the rectangle candidate to be corrected as the rectangle of the detection target in a case where the reliability corrected by the correction processing circuit is equal to or greater than a threshold value, and does not extract the rectangle candidate to be corrected as the rectangle of the detection target in a case where the reliability corrected by the correction processing circuit is less than the threshold value.

### Supplementary Note 8

The image processing apparatus according to any one of Supplementary Notes 1 to 7, wherein the rectangle of the detection target including the reliability corrected by the correction processing circuit is generated as training data used for machine learning.

### Supplementary Note 9

An image processing system including:

the image processing apparatus according to any one of Supplementary Notes 1 to 8; and a training apparatus that generates a trained model by performing machine learning using the training data generated by the image processing apparatus.

Supplementary Note 10 An output apparatus that executes character recognition processing on an input image using the trained model generated by the training apparatus according to Supplementary Note 9 and outputs a character recognition result.

### Supplementary Note 11

An output apparatus including a controller that presents a user with a character recognition result obtained by executing character recognition processing in the image processing apparatus according to any one of Supplementary Notes 1 to 8.

Supplementary Note 12 An image processing method executed by one or more processors and including:

acquiring image data including a plurality of detection targets; detecting a plurality of rectangle candidates corresponding to the plurality of detection targets from the image data, and calculating a reliability for each of the detected rectangle candidates;

in a case where the detected first rectangle candidate and the detected second rectangle candidate at least partially overlap each other, correcting a reliability of a rectangle candidate of a correction target between a first rectangle candidate and a second rectangle candidate using a calculation method for a degree of overlap selected according to a relationship between a type of a first detection target corresponding to the first rectangle candidate and a type of a second detection target corresponding to the second rectangle candidate; and extracting rectangles corresponding to the plurality of detection targets based on the corrected reliability.

### Supplementary Note 13

A recording medium in which an image processing program or a detection program is recorded, the image processing program causing one or more processors to: acquire image data including a plurality of detection targets; detect a plurality of rectangle candidates corresponding to the plurality of detection targets from the image data and calculate a reliability for each of the detected rectangle candidates; correct, in a case where the detected first rectangle candidate and the second rectangle candidate at least partially overlap each other, a reliability of a rectangle candidate of a correction target out of a first rectangle candidate and a second rectangle candidate using a calculation method for a degree of overlap selected according to a relationship between a type of a first detection target corresponding to the first rectangle candidate and a type of a second detection target corresponding to the second rectangle candidate; and extract rectangles corresponding to the plurality of detection targets based on the corrected reliability.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image processing apparatus comprising one or more processors, wherein
the one or more processors:
acquire image data including a plurality of detection targets;
detect a plurality of rectangle candidates corresponding to the plurality of detection targets from the image data;
calculate a reliability for each of the detected rectangle candidates;
correct, in a case where a first rectangle candidate and a second rectangle candidate at least partially overlap each other, a reliability of a rectangle candidate to be corrected out of the first rectangle candidate and the second rectangle candidate by using a calculation method for a degree of overlap selected according to a relationship between a type of a first detection target corresponding to the first rectangle candidate and a type of a second detection target corresponding to the second rectangle candidate; and
extract rectangles corresponding to the plurality of detection targets based on the corrected reliability.

2. The image processing apparatus according to claim 1, wherein
the detection targets are characters, and
the one or more processors select the calculation method depending on whether the type of the first character and the type of the second character are the same.

3. The image processing apparatus according to claim 2, wherein
the type includes a handwritten character and a printed character, and
the one or more processors select a first calculation method in a case where both the first character and the second character are the handwritten characters or the typed characters, and select a second calculation method in a case where one of the first character and the second character is the handwritten character and the other is the typed character.

4. The image processing apparatus according to claim 3, wherein
the first calculation method is a method of calculating a ratio of an area of an overlapping portion to a total area of the first rectangle candidate and the second rectangle candidate, and
the second calculation method is a method of calculating a ratio of the area of the overlapping portion to an area of the rectangle candidate to be corrected.

5. The image processing apparatus according to claim 4, wherein
the one or more processors:
in a case where both the first character and the second character are the handwritten characters or the printed characters,
calculate a correction coefficient corresponding to the ratio calculated by the first calculation method, and correct a reliability of the rectangle candidate to be corrected by multiplying the reliability by the correction coefficient; and
in a case where one of the first character and the second character is the handwritten character and the other is the printed character, calculate a correction coefficient corresponding to the ratio calculated by the second calculation method, and correct the reliability of the rectangle candidate to be corrected by multiplying the reliability by the correction coefficient.

6. The image processing apparatus according to claim 5, wherein
the one or more processors calculate the correction coefficient by referring to correction data having a characteristic that the correction coefficient decreases with an increase in the ratio.

7. The image processing apparatus according to claim 1, wherein
the one or more processors extract the rectangle candidate to be corrected as one of the rectangles corresponding to the plurality of detection targets in a case where the corrected reliability is equal to or greater than a threshold value, and do not extract the rectangle candidate to be corrected as one of the rectangles corresponding to the plurality of detection targets in a case where the corrected reliability is less than the threshold value.

8. The image processing apparatus according to claim 1, wherein
the one or more processors generate the rectangles of the plurality of detection targets including the corrected reliability as training data used for machine learning.

9. An image processing system comprising:
the image processing apparatus according to claim 8; and
a training apparatus that generates a trained model by performing machine learning using the training data generated by the image processing apparatus.

10. An output apparatus that executes character recognition processing on an input image using the trained model generated by the training apparatus according to claim 9, and outputs a character recognition result.

11. An output apparatus that presents a user with a character recognition result obtained by executing character recognition processing in the image processing apparatus according to claim 1.

12. An image processing method executed by one or more processors,
the image processing method comprising:
acquiring image data including a plurality of detection targets;
detecting a plurality of rectangle candidates corresponding to the plurality of detection targets from the image data;
calculating a reliability for each of the detected rectangle candidates;
in a case where the detected first rectangle candidate and the detected second rectangle candidate at least partially overlap each other,
correcting a reliability of a rectangle candidate of a correction target between a first rectangle candidate and a second rectangle candidate using a calculation method for a degree of overlap selected according to a relationship between a type of a first detection target corresponding to the first rectangle candidate and a type of a second detection target corresponding to the second rectangle candidate; and
extracting rectangles corresponding to the plurality of detection targets based on the corrected reliability.

13. A non-transitory computer-readable recording medium in which an image processing program is recorded,
the image processing program causing one or more processors to:
acquire image data including a plurality of detection targets;
detect a plurality of rectangle candidates corresponding to the plurality of detection targets from the image data;
calculate a reliability for each of the detected rectangle candidates;
correct, in a case where a first rectangle candidate and a second rectangle candidate at least partially overlap each other, a reliability of a rectangle candidate to be corrected out of the first rectangle candidate and the second rectangle candidate by using a calculation method for a degree of overlap selected according to a relationship between a type of a first detection target corresponding to the first rectangle candidate and a type of a second detection target corresponding to the second rectangle candidate; and
extract rectangles corresponding to the plurality of detection targets based on the corrected reliability.
